(19) United States
(12) Patent Application Publication
(10) Pub. No.: US 2017/0336203 A1
(43) Pub. Date: Nov. 23, 2017

(54) METHODS AND SYSTEMS FOR REMOTE SENSING WITH DRONES AND MOUNTED SENSOR DEVICES

(71) Applicant: GALILEO GROUP, INC., Melbourne, FL (US)

(72) Inventors: Donald Michael Barnes, Melbourne, FL (US); James Michael Grichnik, Miami Beach, FL (US)

(21) Appl. No.: 15/522,175

(22) PCT Filed: Oct. 26, 2015
(86) PCT No.: PCT/US2015/057420

§ 371 Date: Apr. 26, 2017

Related U.S. Application Data
(60) Provisional application No. 62/068,738, filed on Oct. 26, 2014.
(60) Provisional application No. 62/203,310, filed on Aug. 10, 2015.
(60) Provisional application No. 62/203,312, filed on Aug. 10, 2015.
(60) Provisional application No. 62/206,754, filed on Aug. 18, 2015.
(60) Provisional application No. 62/209,787, filed on Aug. 25, 2015.

(51) Int. Cl. G01C 11/02; G05D 1/00; F21K 5/06; G03B 15/00; G01S 17/88; G05D 1/10; G01C 11/34

(52) U.S. Cl. CPC G01C 11/02; G05D 1/101; G05D 1/0094; G01C 11/34; G03B 15/006; G01S 17/88; G03B 15/0447

(57) ABSTRACT

A self-contained battery-operated device is fixedly mounted to a drone device in a plurality of drone devices. The first self-contained battery-operated device includes one or more processors, an accelerometer, a gyroscope, a location detection device, a two-dimensional pixilated detector, and memory, all connected by a common bus. Time-stamped images of an environmental region are captured using the two-dimensional pixilated detector at a time when the drone device is airborne. For each of the captured time-stamped images, a respective set of meta data is obtained, which includes (1) rotational values obtained using the gyroscope, indicating a relative orientation of the self-contained battery-operated device with respect to a respective reference orientation at a time of image capture, and (2) location information obtained using the location detection device at a time of image capture. The time-stamped images and the respective sets of meta data are sent to a remote processing device.

### TECHNICAL FIELD

This relates generally to image processing and informatics, including but not limited to remote sensing with airborne robotic drones and mounted sensor devices.

### BACKGROUND

The range of applications in which unmanned aerial vehicles, or drones, can be employed for data capture has expanded dramatically. In many situations, however, commercially available drones still have limited sensing and operational capabilities. Also apparently lacking is the ability of a fleet of drones to effectively and efficiently coordinate operations such that captured data can be easily synthesized in a meaningful way.

### SUMMARY

Accordingly, there is a need for faster, more efficient methods, systems, and interfaces for remote sensing with airborne robotic drones and mounted sensor devices. By utilizing the aerial functionality of drone devices, in combination with the robust sensing capabilities of sensor devices, such as smart phones equipped with cameras, accelerometers, and gyroscopes, images and associated meta data may be captured and coordinated among a fleet of devices, and subsequently processed and analyzed. Such methods and interfaces optionally complement or replace conventional methods for remote sensing with robotic drones.

In accordance with some embodiments, a method is performed at a first self-contained battery-operated device (e.g., a first client device/sensor device, such as a smart phone) fixedly mounted to a first drone device in a plurality of drone devices. The first self-contained battery-operated device includes one or more processors, an accelerometer, a gyroscope, a location detection device, a two-dimensional pixilated detector, and memory for storing one or more programs for execution by the one or more processors, all connected by a common bus. The method includes obtaining (e.g., capturing) one or more time-stamped images of an environmental region using the two-dimensional pixilated detector at a time when the drone device is airborne. For each respective time-stamped image of the captured one or more time-stamped images, a respective set of meta data is obtained. The respective set includes (1) rotational values obtained using the gyroscope, the rotational values indicating a relative orientation of the self-contained battery-operated device with respect to a respective reference orientation, and (2) location information obtained using the location detection device at a time when the corresponding time-stamped image is captured. The one or more time-stamped images and the respective sets of meta data for the one or more time-stamped images are sent to a remote processing device.

In accordance with some embodiments, an airborne remote sensing apparatus includes a first drone device and a first self-contained battery-operated device mounted to the first drone device. The self-contained battery-operated device includes one or more processors and memory for storing one or more programs for execution by the one or more processors, the one or more programs include instructions for performing the operations of the client-side method described above.

In accordance with some embodiments, a computer-readable storage medium has stored therein instructions that, when executed by the first self-contained battery-operated device mounted to the first drone device, cause the first self-contained battery-operated device to perform the operations described above.

Thus, drones (e.g. robotic drones) and mounted sensor devices are provided with faster, more efficient methods for remote sensing, thereby increasing the value, effectiveness, efficiency, and user satisfaction with such devices.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating an exemplary device environment for remote sensing using sensor devices mounted to airborne drone devices, in accordance with some embodiments.

FIG. 2 is a block diagram illustrating an exemplary processing device, in accordance with some embodiments.

FIG. 3 is a block diagram illustrating an exemplary client device, in accordance with some embodiments.

FIGS. 4A-4B illustrate an environment for remote sensing using sensor devices mounted to airborne drone devices, in accordance with some embodiments.

FIGS. 5A-5D are flow diagrams illustrating methods for remote sensing using sensor devices mounted to airborne drone devices, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first smart phone could be termed a second smart phone, and, similarly, a second smart phone could be termed a first smart phone, without departing from the scope of the various described embodiments. The first smart phone and the second smart phone are both smart phones, but they are not the same smart phone.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

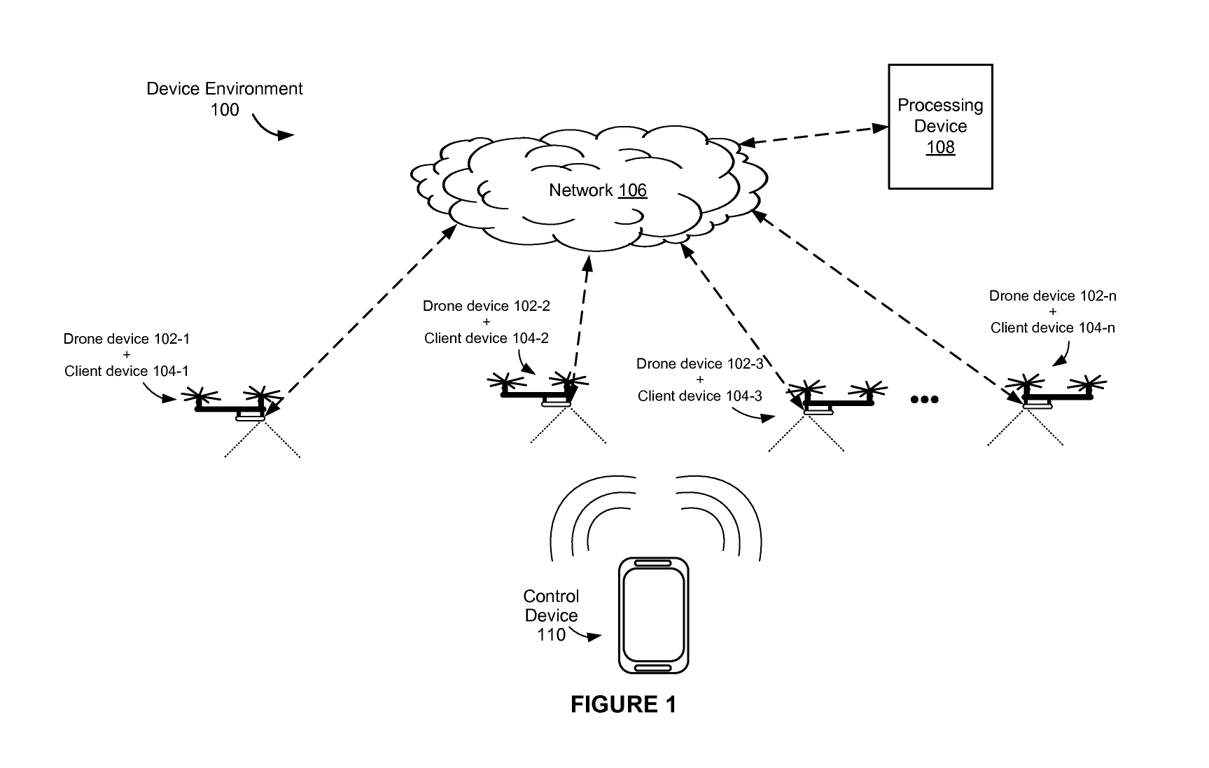

FIG. 1 is a block diagram illustrating an exemplary device environment 100 for remote sensing using sensor devices mounted to airborne drone devices, in accordance with some embodiments.

The device environment 100 includes a number of client devices (also called “client systems,” “client computers,” “clients,” “sensor devices,” etc.) 104-1, 104-2, . . . 104-n fixedly mounted to respective drone devices 102-1, 102-2, . . . 102-n. The client devices 104 and/or the drone device 102 are communicably connected to each other, to one or more processing devices 108, and/or to one or more control devices 110, by one or more networks 106 (e.g., the Internet, cellular telephone networks, mobile data networks, other wide area networks, local area networks, metropolitan area networks, and so on).

In some embodiments, the one or more networks 106 include a public communication network (e.g., the Internet and/or a cellular data network), a private communications network (e.g., a private LAN or leased lines), or a combination of such communication networks. In some embodiments, the one or more networks 106 use the HyperText Transport Protocol (HTTP) and the Transmission Control Protocol/Internet Protocol (TCP/IP) to transmit information between devices or systems. HTTP permits client devices to access various resources available via the one or more networks 106. In some embodiments, the one or more networks 106 are wireless communications channels based on various custom or standard wireless communications protocols (e.g., IEEE 802.15.4, Wi-Fi, ZigBee, 6LoWPAN, Thread, Z-Wave, Bluetooth Smart, ISA100.11a, WirelessHART, MiWi, etc.), or any other suitable communication protocol, including communication protocols not yet developed as of the filing date of this document. Alternatively, in some embodiments, at least a portion of the one or more networks 106 comprise physical interfaces based on wired communications protocols (e.g., Ethernet, USB, etc.). In some implementations, any of the aforementioned devices or systems are communicably connected with each other, or with other devices via any combination of the aforementioned networks 106 (e.g., client devices 104 communicate with one another via Bluetooth, transmit time-stamped images to the processing device 108 via a cellular network, and receive control commands from the control device 110 via Wi-Fi). The various embodiments of the invention, however, are not limited to the use of any particular communication protocol.

In some embodiments, client devices 104 are computing devices or self-contained battery-operated devices, such as smart phones, cameras, video recording devices, smart watches, personal digital assistants, portable media players, tablet computers, 2D devices, 3D (e.g., virtual reality) devices, laptop computers with one or more processors embedded therein or coupled thereto, in-vehicle information systems (e.g., an in-car computer system that provides navigation, entertainment, and/or other information), and/or other appropriate computing devices that can be used to communicate with other client devices, a control device 110, and/or a processing device 108.

In some embodiments, drone devices 102 (also referred to as “unmanned aerial vehicles” (UAV), “remotely piloted aircraft” (RPA), etc.) are robotic aircraft that do not have human pilots aboard. In some embodiments, drone devices 102 execute control commands that include or correspond to instructions and parameters for a flight pattern (e.g., flight line/path, speed, altitude, etc.). In some embodiments, drone devices 102 are autonomous and execute pre-programmed flight patterns. Additionally and/or alternatively, drone devices 102 may be controlled in real-time by a user (e.g., via a remote control device 110) through detected user inputs or generated controls commands. Control commands may be received from mounted devices (e.g., a mounted client device 104), or directly from one or more control devices (e.g., control device 110). In some embodiments, drone devices 102 include one or more processors and memory storing instructions (e.g., received control commands, pre-programmed flight patterns, flight instructions, etc.) for execution by the one or more processors. In some embodiments, the drone device 102 includes at least some of the same operational capabilities and features of the client devices 104, which may be used additionally, alternatively, and/or in conjunction with the client devices 104 (e.g., drone devices 102 include additional sensors that may be used in conjunction with sensors of the client devices 104).

Client devices 104 are mounted to respective drone devices 102, the combination of which may be employed to obtain or generate data for transmission to the processing device 108 and/or other client devices, or to receive, display, and/or manipulate data (e.g., data generated, obtained, or produced on the device itself, data received from the processing device 108 or other client devices, etc.). In some embodiments, the client devices 104 and/or the drone device 102 capture multimedia data (e.g., time-stamped images, video, audio, etc.) and acquire associated meta data (e.g., environmental information (time, geographic location), device readings (sensor readings from accelerometers, gyroscopes, barometers), etc.) for specified environmental regions (e.g., any terrain or geographic area that may be aerially surveyed). Data captured by the client devices 104 and/or the drone device 102 are communicated to the processing device 108 for further processing and analysis. The same or other client devices 104 may subsequently receive data from the processing device 108 and/or other client devices for display (e.g., data visualizations).

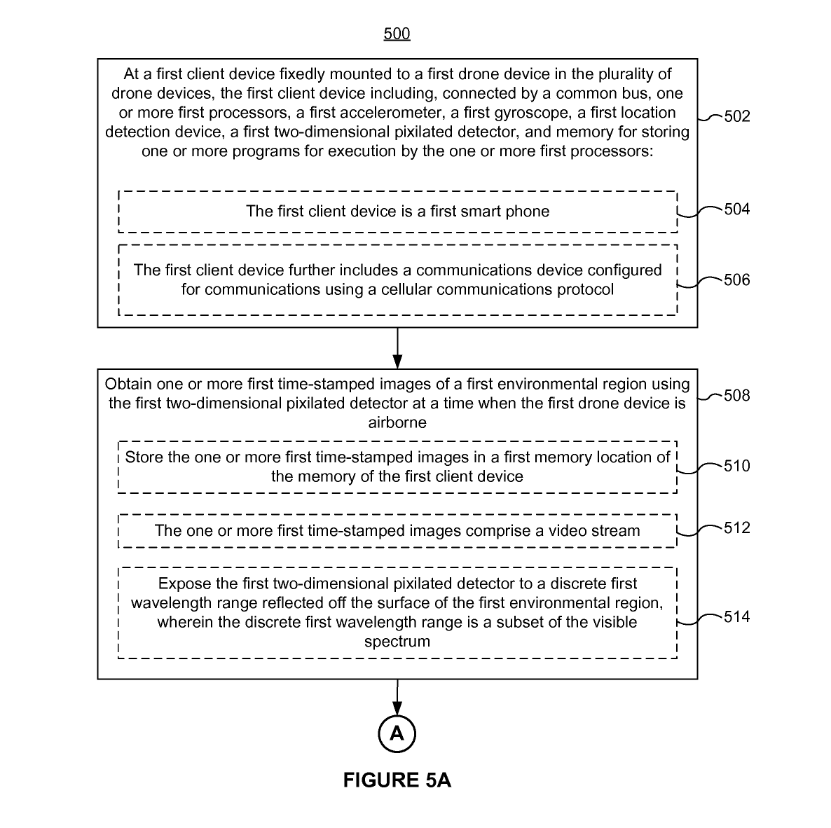

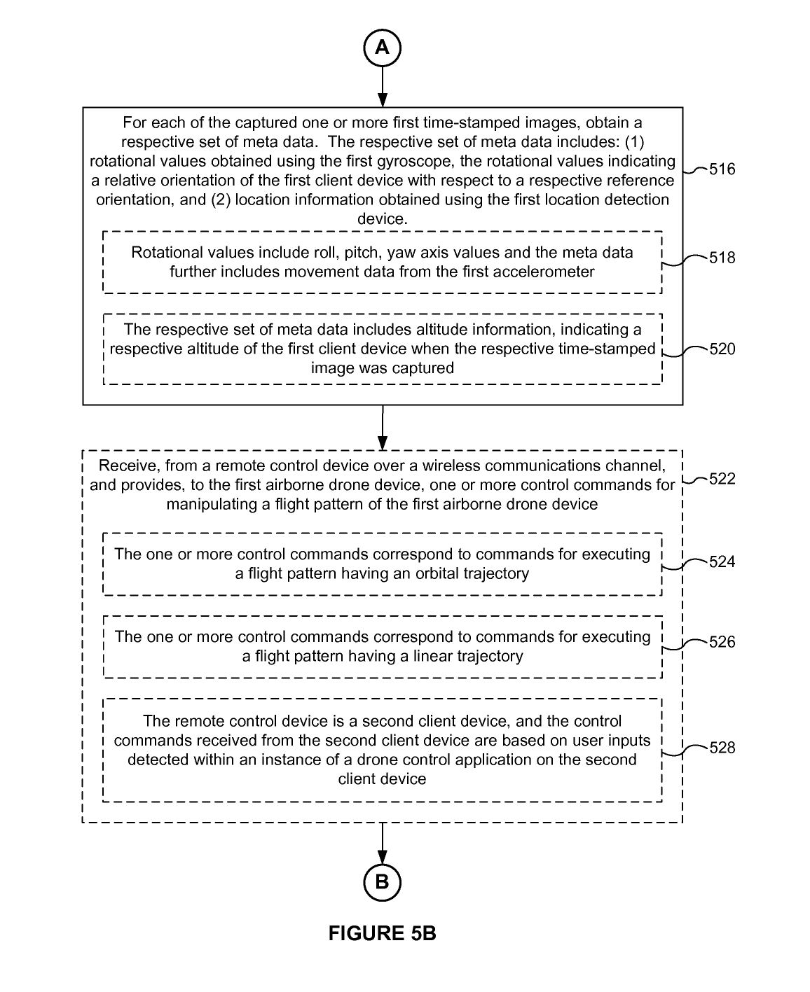

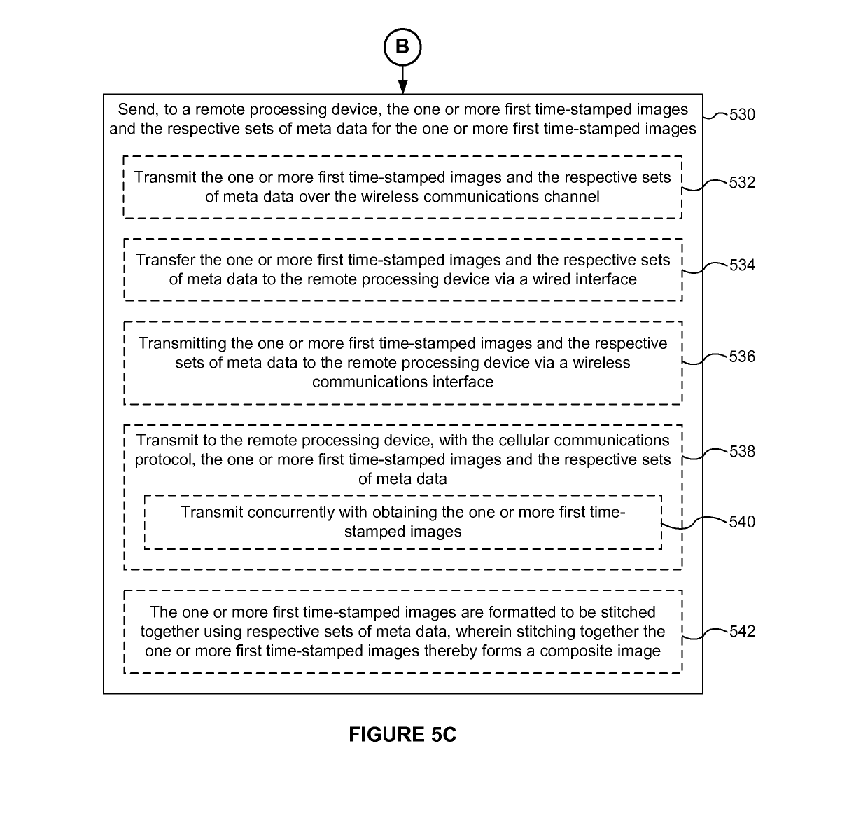

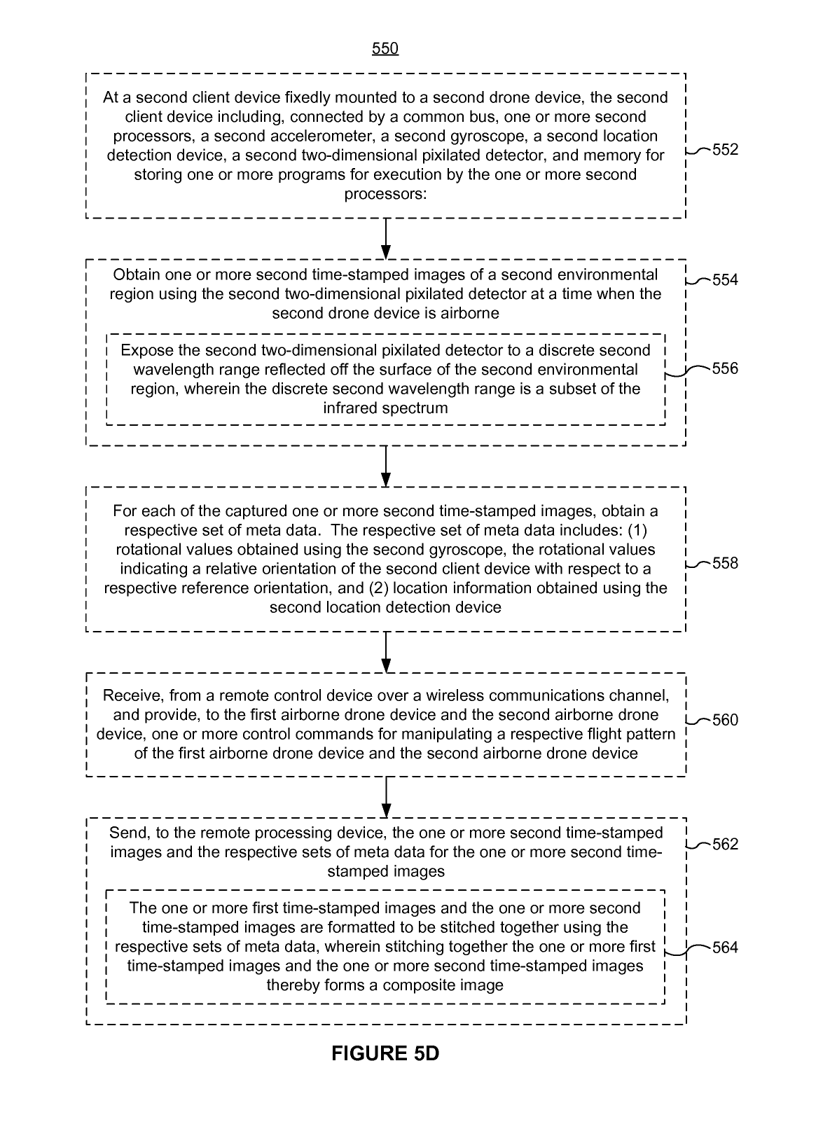

In some embodiments, a control device 110 is any electronic device (e.g., a smart phone, a laptop device, a workstation in a control center, etc.) that generates and transmits control commands for manipulating a flight pattern of one or more airborne drone devices 102. Control commands include instructions and parameters for a flight pattern (e.g., flight line/path, speed, altitude, etc.), and may include a pre-programmed instructions (e.g., transferred to the drone device 102 prior to flight, and later executed) or manual user controls that are transmitted to the client device 104 (and/or the drone device 102) in real-time. In some embodiments, control commands are generated and transmitted by the processing device 108 and/or one or more client devices 104 (used as control devices for synchronizing operational processes of one or more client devices 104 and/or respective drone device 102). Control commands are described in greater detail with respect to the methods 500 and 550 of FIGS. 5A-5D.

In some embodiments, data is sent to and viewed by the client devices in a variety of output formats, and/or for further processing or manipulation (e.g., CAD programs, 3D printing, virtual reality displays, holography applications, etc.). In some embodiments, data is sent for display to the same client device that performs the image capture and acquires sensor readings (e.g., client devices 104), and/or other systems and devices (e.g., processing device 108). In some embodiments, client devices 104 access data and/or services provided by the processing device 108 by execution of various applications. For example, in some embodiments client devices 104 execute web browser applications that can be used to access services provided by the processing device 108. As another example, one or more of the client devices 104-1, 104-2, . . . 104-n execute software applications that are specific to viewing and manipulating data (e.g., visualization “apps” running on smart phones or tablets).

The processing device 108 stores, processes, and/or analyzes data received from one or more client devices 104 and/or drone devices 102 (e.g., multimedia data, respective sets of meta data, etc.). Data resulting from processing and analytical operations are in turn disseminated to the same and/or other client devices for viewing, manipulation, and/or further processing and analysis. In some embodiments, the processing device 108 is a single computing device such as a computer server, while in other embodiments, the processing device 108 is implemented by multiple computing devices working together to perform the actions of a server system (e.g., cloud computing).

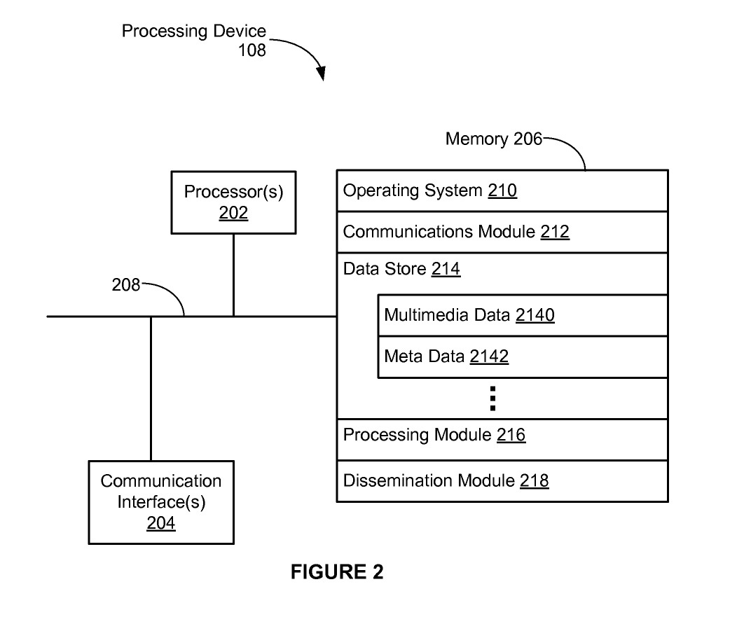

FIG. 2 is a block diagram illustrating an exemplary processing device 108, in accordance with some embodiments. In some embodiments, the processing device 108 is a data repository apparatus, server system, or any other electronic device for receiving, collecting, storing, displaying, and/or processing data received from a plurality of devices over a network.

The processing device 108 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The processing device 108 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

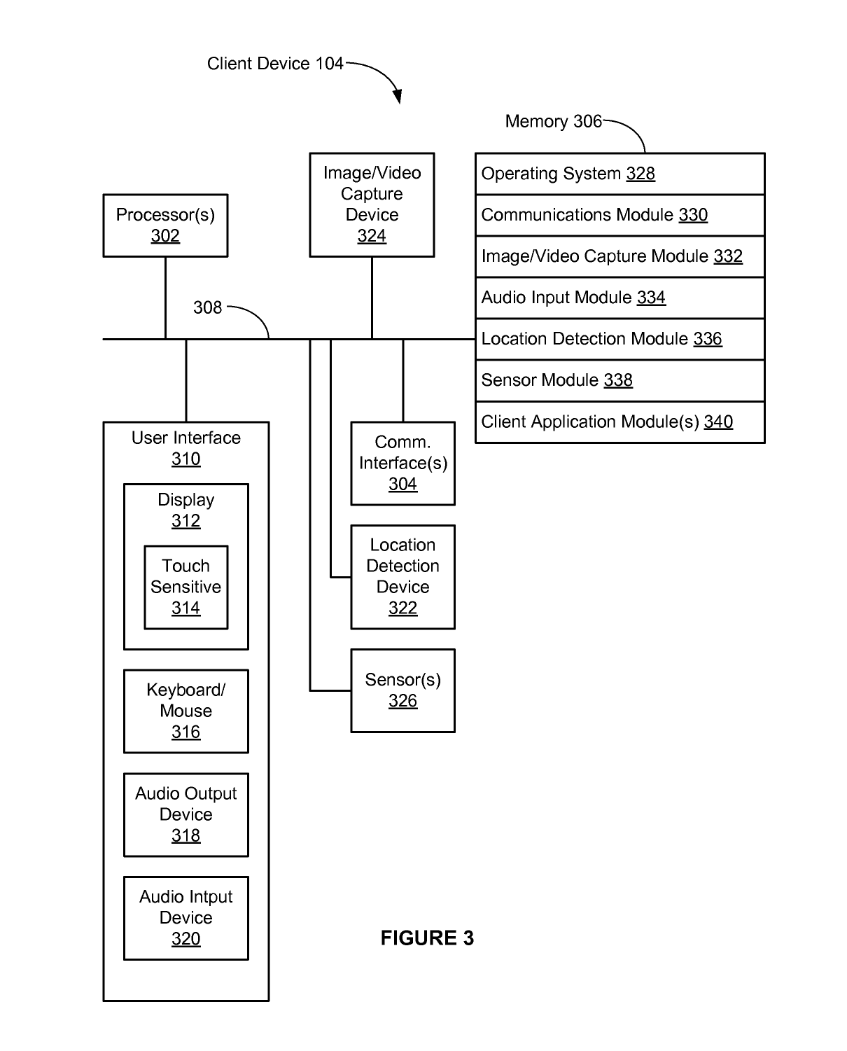

Memory 206 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 206 optionally includes one or more storage devices remotely located from the processor(s) 202. Memory 206, or alternately the non-volatile memory device(s) within memory 206, includes a non-transitory computer-readable storage medium. In some embodiments, memory 206 or the computer-readable storage medium of memory 206 stores the following programs, modules and data structures, or a subset or superset thereof:
an operating system 210 that includes procedures for handling various basic system services and for performing hardware dependent tasks;
a network communication module 212 that is used for connecting the processing device 108 to other computers, systems, client devices 104, and/or drone device 102 via the one or more communication network interfaces 204 (wired or wireless) and one or more communication networks (e.g., the one or more networks 106)
a data store 214 for storing captured data associated with one or more environmental regions and/or imaged subjects/surfaces (e.g., captured by and received from one or more associated client devices 104, FIGS. 1 and 3), such as:
   multimedia data 2140 for storing multimedia data (e.g., time-stamped images, video, audio, etc.) captured by one or more sensors or devices (e.g., two-dimensional pixilated detector and/or microphone of a client device 104, FIG. 3) of the client devices 104 and/or drone devices 102; and
   meta data 2142 for storing meta data (e.g., device data, environmental device measurements, and/or other data associated with captured multimedia) acquired by a client device 104 and/or a respective drone device 102, including but not limited to: device identifiers (e.g., identifying the device of a group of devices that captured the multimedia item, which may include an arbitrary identifier, a MAC address, a device serial number, etc.), temporal data (e.g., date and time of a corresponding capture), location data (e.g., GPS coordinates of the location at which multimedia item was captured), multimedia capture/device settings (e.g., image resolution, focal length, frequency at which images are captured, frequency ranges that a pixilated detector is configured to detect, etc.), sensor frequencies (e.g., the respective frequency at which sensors of a device captured data, such as an accelerometer frequency, a gyroscope frequency, a barometer frequency, etc.), accelerometer readings (e.g., in meters/sec²), translational data (e.g., (x, y, z) coordinates of the device with respect to a pre-defined axes or point of reference), rotational data (e.g., roll (φ), pitch (θ), yaw (ψ)), and/or any additional sensor or device measurements or readings for determining spatial, spectral, and/or temporal characteristics of a device, environmental region, or imaged subjects/surfaces;
processing module 216 for processing, manipulating, and analyzing received data (e.g., from one or more client devices 104 and/or drone device 102) in order to generate visualizations of the received data (e.g., a composite image generated based on received time-stamped images and respective sets of meta data); and
a processing module 218 for processing, analyzing, and extracting data (e.g., biological/non-biological feature data and/or temporal data) from generated spatial, spectral, and/or temporal representations of subject datasets (e.g., constructed maps, dense point clouds, meshes, texture-mapped meshes, etc.), and for detecting temporal observable changes and/or conditions (e.g., potential conditions, health conditions, etc.) (e.g., by correlating data, calculating numerical scores, determining satisfaction of score thresholds, etc.); and
dissemination module 218 for sending generated data (e.g., visualizations) for viewing and/or further processing.

The data store 214 (and any other data storage modules) stores data associated with one or more subjects in one or more types of databases, such as graph, dimensional, flat, hierarchical, network, object-oriented, relational, and/or XML databases, or other data storage constructs.

FIG. 3 is a block diagram illustrating an exemplary client device 104, in accordance with some embodiments.

The client device 104 (e.g., a self-contained battery-operated device, a smart phone, etc.) typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The client device 104 includes a user interface 310. The user interface 310 typically includes a display device 312. In some embodiments, the client device 104 includes inputs such as a keyboard, mouse, and/or other input buttons 316. Alternatively or in addition, in some embodiments, the display device 312 includes a touch-sensitive surface 314, in which case the display device 312 is a touch-sensitive display. In client devices that have a touch-sensitive display 312, a physical keyboard is optional (e.g., a soft keyboard may be displayed when keyboard entry is needed). The user interface 310 also includes an audio output device 318, such as speakers or an audio output connection connected to speakers, earphones, or headphones. Furthermore, some client devices 104 use a microphone and voice recognition to supplement or replace the keyboard. Optionally, the client device 104 includes an audio input device 320 (e.g., a microphone) to capture audio (e.g., speech from a user). Optionally, the client device 104 includes a location detection device 322, such as a GPS (global positioning satellite) or other geo-location receiver, for determining the location of the client device 104.

The client device 104 also optionally includes an image/video capture device 324, such as a camera or webcam. In some embodiments, the image/video capture device 324 includes a two-dimensional pixilated detector/image sensor configured to capture images of environmental regions or other subjects/surfaces, in accordance with one or more predefined capture settings (e.g., resolutions, capture frequencies, etc.). In some embodiments, the client device 104 includes a plurality of image/video capture devices 324 (e.g., a front facing camera and a back facing camera), where in some implementations, each of the multiple image/video capture devices 324 captures a distinct set of images (e.g., capturing images at different resolutions, ranges of light, etc.). Optionally, the client device 104 includes one or more illuminators (e.g., a light emitting diode) configured to illuminate a subject or environment. In some embodiments, the one or more illuminators are configured to illuminate specific wavelengths of light (e.g., ultraviolet, infrared, polarized, fluorescence, for night time operations when there is less than a threshold level of ambient light, for example), and the image/video capture device 324 includes a two-dimensional pixilated detector/image sensor configured with respect to wavelength(s) of the illuminated light. Additionally and/or alternatively, the image/video capture device 324 includes one or more filters configured with respect to wavelength(s) of the illuminated light (i.e., configured to selectively filter out wavelengths outside the range of the illuminated light).

In some embodiments, the client device 104 includes one or more sensors 326 including, but not limited to, accelerometers, gyroscopes, compasses, magnetometer, light sensors, near field communication transceivers, barometers, humidity sensors, temperature sensors, proximity sensors, lasers, range finders (e.g., laser-based), and/or other sensors/devices for sensing and measuring various environmental conditions. In some embodiments, the one or more sensors operate and obtain measurements at respective predefined frequencies.

Memory 306 includes high-speed random-access memory, such as DRAM, SRAM, DDR RAM or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 302. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 328 that includes procedures for handling various basic system services and for performing hardware dependent tasks;
a network communication module 330 that is used for connecting the client device 104 to other computers, systems (e.g., processing device 108), control devices (e.g., control device 110), client devices 104, and/or drone device 102 via the one or more communication network interfaces 304 (wired or wireless) and one or more communication networks (e.g., Internet, cellular telephone networks, mobile data networks, other wide area networks, local area networks, metropolitan area networks, IEEE 802.15.4, Wi-Fi, Bluetooth, etc.);
an image/video capture module 332 (e.g., a camera module) for processing and storing respective images or videos captured by the image/video capture device 324, where the respective image or video may be sent or streamed (e.g., by a client application module 336) to the processing device 108;
an audio input module 334 (e.g., a microphone module) for processing audio captured by the audio input device 320, where the respective audio may be sent or streamed (e.g., by a client application module 340) to the processing device 108;
a location detection module 336 (e.g., a GPS, Wi-Fi, or hybrid positioning module) for determining the location of the client device 104 (e.g., using the location detection device 322) and providing this location information for use in various applications (e.g., client application module 340);
a sensor module 338 for obtaining, processing, and transmitting meta data (e.g., device data, environmental device measurements, and/or other data associated with captured multimedia) acquired by the client device 104 and/or a respective drone device 102, including but not limited to: device identifiers (e.g., identifying the device of a group of devices that captured the multimedia item, which may include an arbitrary identifier, a MAC address, a device serial number, etc.), temporal data (e.g., date and time of a corresponding capture), location data (e.g., GPS coordinates of the location at which multimedia item was captured), multimedia capture/device settings (e.g., image resolution, focal length, frequency at which images are captured, frequency ranges that a pixilated detector is configured to detect, etc.), sensor frequencies (e.g., the respective frequency at which sensors of a device captured data, such as an accelerometer frequency, a gyroscope frequency, a barometer frequency, etc.), accelerometer readings (e.g., in meters/sec²), translational data (e.g., (x, y, z) coordinates of the device with respect to a pre-defined axes or point of reference), rotational data (e.g., roll (φ), pitch (θ), yaw (ψ)), and/or any additional sensor or device measurements or readings for determining spatial, spectral, and/or temporal characteristics of the client device, a drone device to which the client device is mounted, environmental regions, and/or imaged subjects/surfaces; and
one or more client application modules 340, including the following modules (or sets of instructions), or a subset or superset thereof:
   a drone control module for receiving (e.g., from a control device 110, FIG. 1), generating (e.g., based on detected user inputs, pre-programmed/autonomous flight patterns, etc.), storing, providing, and/or re-broadcasting control commands to client devices 104 and/or associated drone devices 102 to which they are mounted;
   a web browser module (e.g., Internet Explorer by Microsoft, Firefox by Mozilla, Safari by Apple, or Chrome by Google) for accessing, viewing, and interacting with web sites (e.g., a social-networking web site provided by the processing device 108), captured data (e.g., time-stamped images), and/or generated visualizations of captured data (e.g., composite image); and/or
   other optional client application modules for viewing and/or manipulating captured data or received data, such as applications for photo management, video management, a digital video player, computer-aided design (CAD), 3D viewing (e.g., virtual reality), 3D printing, holography, and/or other graphics-based applications.

In some embodiments, the control device 110 (FIG. 1) is a client device 104 (FIG. 3) that includes a control module (e.g., drone control module of client application module 340, FIG. 3) for generating and providing control commands to client devices 104 and/or associated drone devices 102 to which they are mounted. In some embodiments, the control device 110 (FIG. 1) is a processing device 108 that includes one or more additional modules (e.g., drone control module of client application module 340, FIG. 3) for generating and providing control commands to client devices 104 and/or associated drone devices 102 to which they are mounted. In some embodiments, client devices 104 are control devices in and of themselves, such that they generate control commands (e.g., based on detected user inputs in a drone control application) to be provided to their associated drone devices, and/or to other client devices/drone devices (e.g., nearby drone devices that form a fleet of drone devices).

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

Furthermore, in some implementations, the functions of any of the devices and systems described herein (e.g., client devices 104, drone device 102, processing device 108, control device 110, etc.) are interchangeable with one another and may be performed by any other devices or systems, where the corresponding sub-modules of these functions may additionally and/or alternatively be located within and executed by any of the devices and systems. As one example, although the client device 104 (FIG. 3) includes sensors and modules for obtaining/processing images (e.g., sensors 326 and an image/video capture module 332) and obtaining respective sets of meta data (e.g., sensor module 338), in some embodiments the drone device 102 may include analogous modules, components, and device capabilities for performing the same operations (e.g., sensors and modules containing instructions for obtaining images and respective meta data). The devices and systems shown in and described with respect to FIGS. 1 through 3 are merely illustrative, and different configurations of the modules for implementing the functions described herein are possible in various implementations.

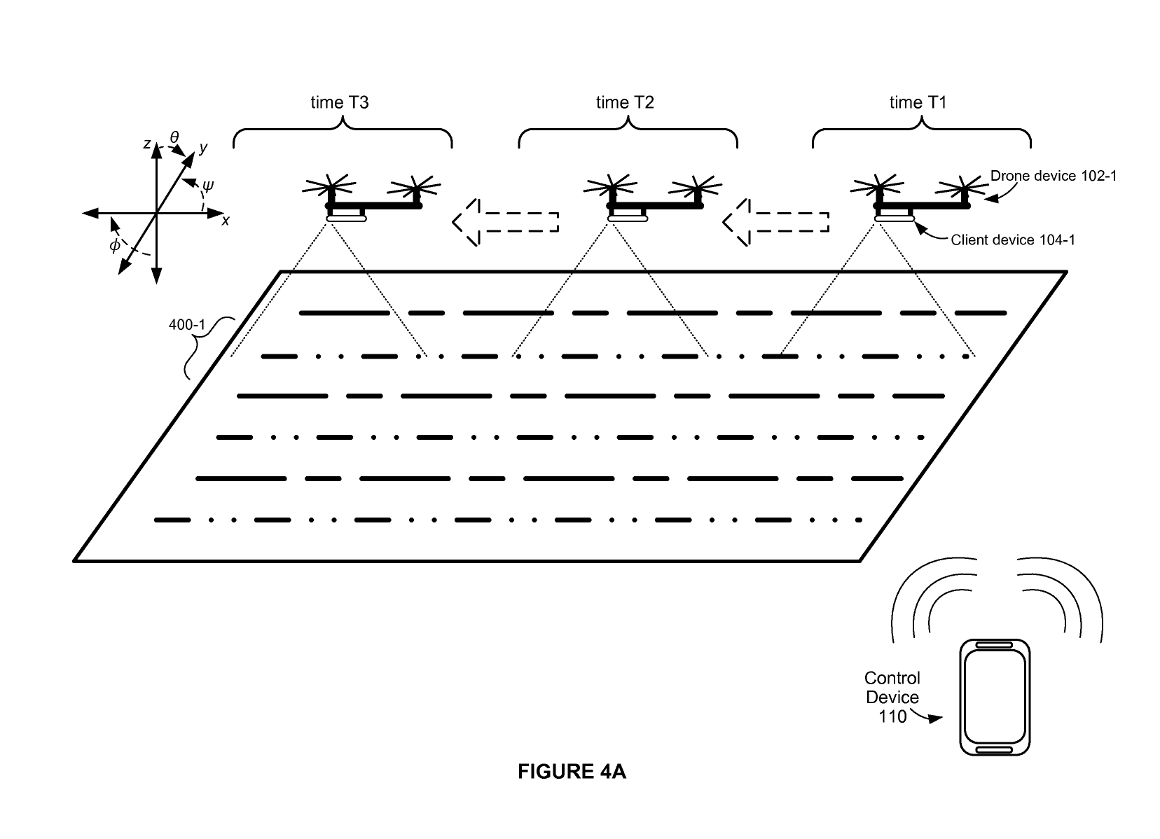

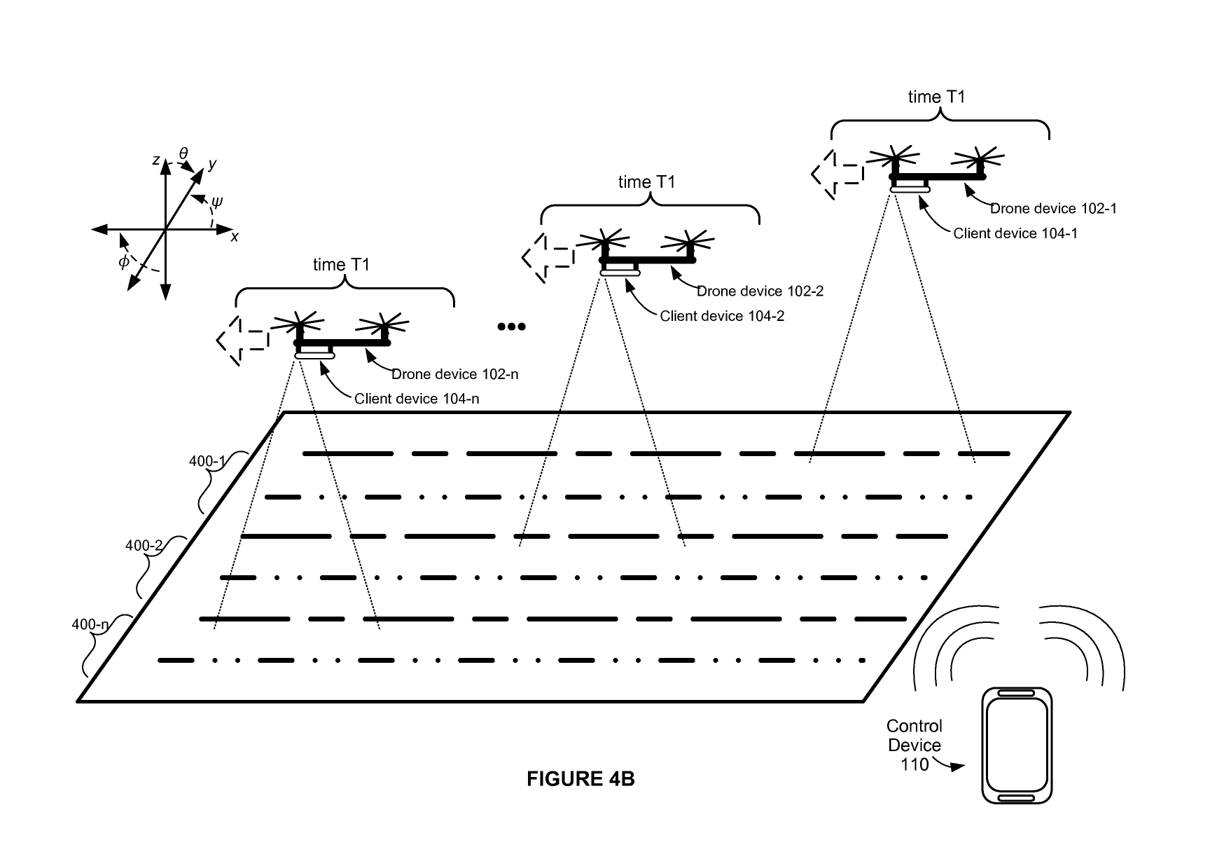

FIGS. 4A-4B illustrate an environment for remote sensing using sensor devices mounted to airborne drone devices, in accordance with some embodiments.

Specifically, the environment shown in FIG. 4A includes a single client device 104-1 mounted to a drone device 102-1 for capturing images of an environmental region 400-1, and for acquiring corresponding meta data for the captured images (e.g., various sensor readings that indicate orientation, location information, etc.). An optional control device 110 generates and sends control commands to the client device 104-1 and/or the drone device 102-1 for manipulating a flight pattern of the drone device. In some embodiments, the client device 104-1 is a self-contained battery-operated device, a smart phone, or any electronic device with image capture capabilities (e.g., camera, PDA, etc.).

The client device 104-1 is used to capture one or more still-frame images, video sequences, and/or audio recordings of the environmental region 400-1 (i.e., multimedia data) from one or more aerial positions and angles. FIG. 4A illustrates an example in which a respective time-stamped image is captured at various intervals of time (e.g., T1, T2, T3, etc.) during the flight pattern of the drone device 102-1. In the example shown, the flight pattern of the drone device 102-1 has a linear trajectory (although as described below, the flight pattern can be manipulated or modified prior to or during the course of flight).

Concurrently with image capture, the client device 104-1 also acquires respective meta data for the time-stamped images as the location and orientation of the client device changes throughout the flight pattern. Meta data includes rotational values indicating a relative orientation of the client device 104-1 with respect to a respective reference orientation (e.g., roll (φ), pitch (θ), yaw (ψ)), location information of the client device (e.g., GPS coordinates, relative position with respect to the environmental region, etc.), and/or other various environmental conditions (e.g., altitude, temperature, etc.). FIG. 4A illustrates a set of predefined axes with respect to which a relative orientation of the client device 104-1 can be determined. In the example shown, rotational values of the client device are defined as an angle of rotation within the x-y axis (i.e., yaw (ψ)), an angle of rotation within the y-z axis (i.e., pitch (θ)), and an angle of rotation within the x-z axis (i.e., roll (φ). Meta data is based on and includes various time-stamped sensor readings obtained from one or more sensors of the client device 104-1 (e.g., sensors 326, such as an accelerometer, gyroscope, barometer, etc.). Other types of meta data and its use is described in greater detail below with respect to FIGS. 5A-5D.

Once obtained, time-stamped images and respective sets of meta data are sent to a processing device (e.g., processing device 108, FIG. 1) for further processing and analysis. In some embodiments, the images and meta data are sent while the drone device 102-1 is in flight (e.g., via a wireless communications channel), while in other embodiments, the images and meta data are transferred once the flight program and image capture session has completed (e.g., via a wired interface coupled with the processing device). In some embodiments, the time-stamped images are stitched together using the respective sets of meta data (e.g., using location and time-stamp information for alignment) in order to form a composite image. The composite image can then be further processed and analyzed to identify and detect various conditions concerning the environmental region 400-1 or portions thereof (e.g., crop yield, plant pathology, etc.).

FIG. 4B illustrates an environment in which a plurality of client devices 104 (e.g., 104-1, 104-2, . . . 104-n) mounted to respective drone devices 102 (e.g., 102-1, 102-2, . . . 102-n) is used for capturing images of multiple environmental regions 400 (e.g., 400-1, 400-2, . . . 400-n) or portions thereof, and for acquiring corresponding meta data for the captured images (e.g., orientation, location information, etc.). The optional control device 110 generates and sends control commands to one or more of the client devices 104 and/or the drone devices 102.

The use of multiple client devices 104 and drone devices 102 is advantageous for obtaining and acquiring comprehensive data, and ultimately for enabling an enhanced analytical approach to processing data. By concurrently using multiple devices for image capture, data may be captured for larger environmental regions with greater efficiency and effectiveness. Moreover, additional client devices 104 may be used to acquire time-stamped images and sensor readings from a variety of viewpoints and angles.

In addition to providing coverage for designated environmental regions, individual drone devices 102 (or subsets of a plurality of drone devices 102) may also be programmed to execute specific and distinct flight patterns (e.g., an orbital trajectory for a first drone device 102-1, and a linear trajectory for a second drone device 102-2).

Multiple client devices 104 may also be used to capture images in accordance with different sets of capture settings. For example, each client device 104 of a fleet can capture images at a different resolution (e.g., a first client device 104-1 for capturing low-resolution images, a second client device 104-2 for capturing high-resolution images), and/or to capture images representing a distinct frequency (or range of frequencies) of light (e.g., a first client device 104-1 configured to detect visible light frequencies, a second client device 104-2 configured to detect IR light frequencies).

The use of multiple client devices 104 and drone devices 102 is described in greater detail below with respect to FIGS. 5A-5D.

FIGS. 5A-5D are flow diagrams illustrating methods 500 and 500 for remote sensing using sensor devices mounted to airborne drone devices, in accordance with some embodiments. In some implementations, the methods 500 and 550 are performed by one or more devices of one or more systems (e.g., client devices 104, drone devices 102, control devices 110, and/or processing devices 108 of a device environment 100, FIGS. 1-3), or any combination thereof. Thus, in some implementations, the operations of the methods 500 and 500 described herein are entirely interchangeable, and respective operations of the methods 500 and 500 are performed by any one of the aforementioned devices and systems, or combination of devices and systems. For ease of reference, the methods herein will be described as being performed by a client device (e.g., a first client device 104-1, a second client device 104-2, etc.) of a device environment 100 (e.g., FIG. 1). While parts of the methods are described with respect to a client device, any operations or combination of operations of the methods 500 and 500 may be performed by any electronic device having image capture capabilities (e.g., a self-contained battery-operated device, such as a smart phone, a camera device, a computer-enabled imaging device, a PDA, etc.).

The method 500, described with respect to FIGS. 5A-5C, corresponds to instructions/programs stored in a memory (e.g., memory 306, FIG. 3) or other computer-readable storage medium of a first client device (e.g., client device 104-1, FIGS. 1 and 3). The method 500 is performed (502) at the first client device fixedly mounted to a first drone device (e.g., client device 104-1 mounted to drone device 102-1, FIG. 4A) in a plurality of drone devices. The first client device includes one or more first processors (e.g., 302), a first accelerometer (e.g., sensor 326), a first gyroscope (e.g., sensor 326), a first location detection device (e.g., location detection device 322), a first two-dimensional pixilated detector (e.g., image/video capture module 332), and memory for storing one or more programs for execution by the one or more first processors (e.g., memory 305), all connected by a common bus (e.g., communication bus 308). Optionally, the first client device includes one or more additional sensors (e.g., barometer, compass, light sensors, etc.) for acquiring additional sensor readings that may be used as additional mathematical variables in processing operations (e.g., in generating the composite image).

In some embodiments, the first client device is fixedly mounted to the first drone device such that sensor readings by the first client device are substantially representative of environmental conditions associated with the first drone device. For example, sensor readings obtained by the first client device that indicate an orientation of the first client device, also indicate an orientation of the first drone device to which the first client device is mounted. In other words, in some embodiments, because the first client device and the first drone device are fixedly mounted, their respective orientations are substantially the same. Similarly, as another example, a location of the first client device (derived from sensor readings acquired by the first client device) is substantially the same as a location of the first drone device.

In some embodiments, the first client device is (504) a first smart phone. In some embodiments, the first client device further includes (506) a communications device configured for communications using a cellular communications protocol (e.g., communications module 212 for communicating using a CDMA based protocol, FIG. 2).

The first client device obtains (508) one or more first time-stamped images of a first environmental region using the first two-dimensional pixilated detector at a time when the first drone device is airborne. An environmental region is any viewable surface, terrain, or geographic area that may be aerially surveyed, such as crop fields, urban landscapes, etc. In some embodiments, once a flight pattern is executed and the first drone device becomes airborne, the first client device commences image capture and obtains the one or more first time-stamped images of the first environmental region (e.g., environmental region 400-1, FIG. 1). An example is illustrated and described with respect to FIG. 4A, where the client device 104-1 captures a respective image at sequential times T1, T2, and T3 while the drone device 102-1 is airborne and executing a flight pattern having a linear trajectory.

In some embodiments, the obtaining (508) includes storing (510) the one or more first time-stamped images in a first memory location of the memory of the first client device (e.g., image/video capture module 332, FIG. 3). In some embodiments, the one or more first time-stamped images comprise (512) a video stream (i.e., video capture/streaming for a capture session).

In some embodiments, the one or more first time-stamped images are obtained in accordance with one or more image capture settings (e.g., a frequency of image capture, capture duration, capture start/end time, configuration settings for captured images, such as a resolution, zoom, focal length, etc.). For example, in some embodiments, the first two-dimensional pixilated detector is exposed (514) to a discrete first wavelength range reflected off the surface of the first environmental region, wherein the discrete first wavelength range is a subset of the visible spectrum. In some embodiments, the one or more image capture settings are based on parameters of the flight pattern of the first drone device (e.g., the first frequency is based on a current speed of the first drone device, a type of trajectory, a height above the environmental region, etc.). In some embodiments, one or more image capture settings are adjusted in accordance with detected changes in the flight pattern of the first drone device. For example, a headwind that reduces a speed of the first drone device causes a frequency of image capture to be adjusted such that the one or more first time-stamped images are captured at a lower frequency. Conversely, a tailwind that increases the speed of the first drone device causes the frequency of image capture to be adjusted such that the one or more first time-stamped images are captured at a higher frequency.

In some embodiments, after obtaining (508) the one or more first time-stamped images of the first environmental region (e.g., after completing a first image capture session), the first client device obtains one or more subsequent time-stamped images of an additional environmental region. In some embodiments, the additional environmental region is at least partially distinct from the first environmental region (e.g., adjacent to, but partially overlapping the first environmental region). In some embodiments, while obtaining the one or more subsequent time-stamped images, the first drone device executes a flight pattern in accordance with the flight pattern executed by the first drone device while obtaining the one or more first time-stamped images. As an example, while obtaining a first set and a second set of time-stamped images, the drone device executes respective flight patterns having parallel flight lines (e.g., linear trajectory) so as to methodically canvas a large geographic area having multiple, parallel environmental regions.

Referring now to FIG. 5B, for each of the captured one or more first time-stamped images, a respective set of meta data is obtained (516). The respective set of meta data includes: (1) rotational values obtained using the first gyroscope, the rotational values indicating a relative orientation of the first client device with respect to a respective reference orientation, and (2) location information obtained using the first location detection device. In some embodiments, rotational values include (518) roll, pitch, yaw axis values (e.g., with respect to a predefined axis, FIG. 4A), and the meta data further includes movement data from the first accelerometer (e.g., flight speed, headwind/tailwind speeds, etc.). In some embodiments, location information includes a geographical position (e.g., GPS coordinates) of the first client device at a respective time at which a time-stamped image was captured. In some embodiments, location information includes a relative position of the first client device with respect to a coordinate system defined by an area that encloses the first environmental region (e.g., x-y coordinates of the client device 104-1 at respective times T1, T2, and T3, with respect to the geographical area illustrated in FIG. 4A that encloses the environmental region 400-1). In some embodiments, location information includes a relative distance between the first client device and one or more other client devices of the plurality of client devices (e.g., distance between client device 104-1 and 104-2). In some embodiments, the respective set of meta data includes (520) altitude information, indicating a respective altitude of the first client device when the respective time-stamped image was captured (e.g., obtained using a pressure sensor of the client device, such as a barometer; using a small laser or laser range finder of the client device to pulse true distance from the drone device to the ground).

In some embodiments, the first client device receives (522), from a remote control device over a wireless communications channel, and provides, to the first airborne drone device, one or more control commands for manipulating a flight pattern of the first airborne drone device. Control commands include instructions (e.g., to be executed by the first client device and/or the first drone device) for one or more parameters of a flight pattern, including but not limited to a speed (e.g., changing current speed, enabling variable speed, etc.), an altitude, an orientation (e.g., yaw, pitch roll), a flight duration, a trajectory (e.g., linear, orbital), a flight line (e.g., a specific path/environmental region over which the drone device spans), and/or any other parameters affecting the flight behavior of the first drone device. In some embodiments, the one or more control commands correspond (524) to commands for executing a flight pattern having an orbital trajectory. In some embodiments, the one or more control commands correspond (526) to commands for executing a flight pattern having a linear trajectory. Additionally, control commands may also include instructions for obtaining time-stamped images in accordance with one or more image capture settings (e.g., instructions for modifying existing image capture settings for the first client device, such as changing a frequency of image capture, a capture resolution, a capture duration, a start/end time, etc.).

In some embodiments, the one or more control commands include a pre-programmed set of instructions (e.g., corresponding to predefined parameters of a flight pattern to be executed, such as a flight line, speed, altitude, etc.). By executing control commands that include a pre-programmed flight pattern, drone devices thus become autonomous (and do not require user intervention) from the moment of turning on, or the flight pattern being initiated. In some embodiments, the one or more control commands (e.g., a pre-programmed flight pattern) are received by the first client device (and subsequently provided to the drone device) before initiating a capture session and before executing a flight pattern of the first drone device (i.e., before the drone device is airborne).

Alternatively, in some embodiments, the remote control device is (528) a second client device (e.g., client device 104 of FIG. 3, a smart phone), and the control commands received from the second client device are based on user inputs detected within an instance of a drone control application on the second client device (e.g., a drone control module of client application modules 340, FIG. 3). For example, the control commands are based on flight controls generated by user inputs detected on a control device 110 (e.g., user inputs corresponding to directional commands for adjusting a roll, pitch, and/or yaw of the drone device 102-1). In some embodiments, the one or more control commands are received by the first client device, and provided to the first drone device, in real-time while the first drone device is in flight (e.g., a current flight pattern of the drone device is modified in flight). In some embodiments, the one or more control commands received in real-time override an existing flight pattern being executed by the first drone device (e.g., a pre-programmed flight trajectory of the first drone device is modified such that the user manually steers the flight path in real-time).

In some embodiments, the control device is an electronic device or system (e.g., a smart phone, a laptop device, a workstation in a control center, etc.) that includes memory storing one or more modules (e.g., a drone control application) for generating and transmitting control commands to the first client device and/or the first drone device.

In some embodiments, the wireless communications channel is based on a cellular communications protocol (e.g., CDMA, GSM). In other embodiments, the wireless communications channel is based on a wireless communications protocol (e.g., IEEE 802.11 Wi-Fi, Wi-Fi direct, Bluetooth, IEEE 802.15.4, etc.).

Alternatively, in some embodiments, the first drone device receives, from the remote control device (e.g., a laptop, smart phone, etc.), one or more control commands for execution (e.g., via a cellular connect, Wi-Fi direct, Bluetooth, etc.). That is, in some embodiments, the first drone device receives control commands directly, rather than from the first client device. In some embodiments, the first drone device is preloaded with the one or more control commands that include a pre-programmed flight pattern (e.g., drone device is autonomous upon being powered on, mounted, operationally initiated, etc.).

Referring now to FIG. 5C, in some embodiments, the first client device sends (530), to a remote processing device (e.g., processing device 108, FIG. 1), the one or more first time-stamped images and the respective sets of meta data for the one or more first time-stamped images. Once received, the remote processing device performs one or more subsequent processing operations for synthesizing and analyzing the one or more first time-stamped images using the respective sets of meta data.

In some embodiments, the sending includes (532) transmitting the one or more first time-stamped images and the respective sets of meta data over the wireless communications channel (of step 522) (i.e., the same wireless communications channel over which control commands are received by the first client device). In other embodiments, the sending includes transmitting the one or more first time-stamped images and the respective sets of meta data over a wireless communications channel that is distinct from the wireless communications channel over which the one or more control commands were received (e.g., transmitting images and meta data over cellular communications channel, while receiving control commands over Wi-Fi).

In some embodiments, the sending includes (534) transferring the one or more first time-stamped images and the respective sets of meta data to the remote processing device via a wired interface (e.g., transferring over a USB cable interface between the processing device 108 and the client device 104-1 at the conclusion of an image capture and flight session, FIG. 1). In some embodiments, the sending includes transferring the images to the remote processing device via a removable storage device (e.g., a flash drive).

In some embodiments, the sending includes (536) transmitting the one or more first time-stamped images and the respective sets of meta data to the remote processing device via a wireless communications interface (e.g., IEEE 802.11 Wi-Fi, Bluetooth, etc.). In some embodiments, the sending includes (538) transmitting to the remote processing device, with the cellular communications protocol (e.g., GSM, CDMA), the one or more first time-stamped images and the respective sets of meta data. In some embodiments, the transmitting is performed (540) concurrently with obtaining the one or more first time-stamped images. In other words, the one or more first time-stamped images and the respective sets of meta data are transmitted during, rather than at the conclusion of, an image capture and flight session (i.e., streaming images and meta data in flight and in real-time as it is obtained). In some embodiments, the sending is performed subsequent to obtaining the one or more first time-stamped images and the respective set of meta data (e.g., transferring to the remote processing device at the conclusion of the image capture and flight session).

In some embodiments, a first portion of the one or more time-stamped images and the respective sets of meta data is sent while in flight (e.g., via a wireless communications channel), while a second portion (e.g., a remaining portion) is transferred after the mission is complete (e.g., via a removable storage device).

In some embodiments, the one or more first time-stamped images are formatted (542) to be stitched together using respective sets of meta data, wherein stitching together the one or more first time-stamped images thereby forms a composite image. In some embodiments, stitching includes determining an order in which all or a subset of time-stamped images are arranged in order to form the composite image, wherein the order is determined by matching time-stamped images based on the obtained meta data (e.g., matching time stamps, identifying images having adjacent locations, etc.).

In some embodiments, aspects of the composite image are enhanced by using the respective set of meta data (e.g., sensor readings). Enhanced aspects of the composite image include straightness of line boundaries, color accuracy, and/or alignment of portions of the composite image. For example, inertial meta data obtained from gyroscopes of the first client device may be used to compensate and straighten distorted image data resulting from unsteady flight lines due to environmental conditions.

As described with respect to FIG. 4B, the use of multiple client devices 104 and drone devices 102 is advantageous for a variety of reasons, which includes capturing image data for larger environmental regions to generate a more comprehensive composite image, and utilizing distinct flight patterns, image capture settings, and control commands. Additional features and advantages enabled by the use of multiple client devices 104 and drone devices 102 are described in greater detail below with respect to the method 550 in FIG. 5D.

In some embodiments, the method 550 is performed (552) at a second client device fixedly mounted to a second drone device (e.g., client device 104-2 mounted to drone device 102-2, FIG. 4B) of the plurality of drone devices, where the plurality of drone devices includes the first drone device (e.g., drone device 102-1, with respect to which the method 500 is described). The second client device includes one or more second processors (e.g., 302), a second accelerometer (e.g., sensor 326), a second gyroscope (e.g., sensor 326), a second location detection device (e.g., location detection device 322), a second two-dimensional pixilated detector (e.g., image/video capture module 332), and memory for storing one or more programs for execution by the one or more second processors (e.g., memory 305), all connected by a common bus (e.g., communication bus 308).

In some embodiments, the second client device obtains (554) one or more second time-stamped images of a second environmental region using the second two-dimensional pixilated detector at a time when the second drone device is airborne. In some embodiments, the first client device obtaining the one or more first time-stamped images (step 508, FIG. 5A) and the second client device obtaining the one or more second time-stamped images are performed concurrently (e.g., during the same image capture and flight session), while in other embodiments, they are performed at different times.

In some embodiments, the second environmental region is distinct from the first environment region that corresponds to the one or more first time-stamped images obtained by the first client device (step 508, FIG. 5A). For example, as shown in FIG. 4B, the flight lines of the drone devices 102-1 and 102-2 span distinct environmental regions of the area such that the client devices 104-1 and 104-2 obtain time-stamped images of their respective regions. In some embodiments, the second client device obtains one or more second time-stamped images of the same first environmental region (rather than a different environmental region), but in accordance with a flight pattern (i.e., flight parameters) of the second drone device that is distinct from the flight pattern of the first airborne drone device. For example, the second drone device may fly over the same environmental region as the first drone device, but at a lower altitude or speed, or with the second client device capturing images at a different frequency and/or resolution.

In some embodiments, the one or more second time-stamped images are obtained in accordance with one or more image capture settings (e.g., a frequency of image capture, configuration settings for captured images, such as a resolution, zoom, focal length, etc.) that are the same, or at least partially distinct from, the one or more image capture settings used for obtaining the first time-stamped images (step 508, described in FIG. 5A with respect to the first client device). In some embodiments, the second two-dimensional pixilated detector is exposed (556) to a discrete second wavelength range reflected off the surface of the second environmental region, wherein the discrete second wavelength range is a subset of the infrared spectrum. In some embodiments, the second two-dimensional pixilated detector is exposed to a discrete second wavelength range reflected off the surface of the first environmental region (rather than a distinct second environmental region). Thus, the first client device and the second client device obtain respective time-stamped images representing the same environmental region, where the respective time-stamped images correspond to different frequencies (or frequency bands) of light, providing a layered representation of spectral data for a given environmental region (e.g., a first set of time-stamped images corresponding to IR, a second set of time-stamped images corresponding to UV, etc.).

In some embodiments, for each of the captured one or more second time-stamped images, the second client device obtains (558) a respective set of meta data. The respective set of meta data includes: (1) rotational values (e.g., with respect to a predefined axis, FIG. 4A) obtained using the second gyroscope, the rotational values indicating a relative orientation of the second client device with respect to a respective reference orientation, and (2) location information obtained using the second location detection device.

In some embodiments, the second client device receives (560), from a remote control device over a wireless communications channel, and provides, to the first airborne drone device and the second airborne drone device, one or more control commands for manipulating a respective flight pattern of the first airborne drone device and the second airborne drone device. In some embodiments, the remote control device (e.g., a laptop, a smart phone with a drone control application, etc.) is the same remote control device from which the first client device receives control commands (step 522, FIG. 5B). In some embodiments, the first and second client devices (and/or the first and second drone devices) receive, over a wireless communications channel, and provide, to the respective first and second drone devices, one or more control commands (e.g., a laptop, a smart phone with a drone control application, etc. sending control commands to both the first and second devices).

In some embodiments, the one or more control commands include a first respective set of control commands for the first drone device, and a second respective set of control commands for the second drone device. In some embodiments, the respective sets of control commands for the first and second drone device are distinct with respect to at least some parameters of their respective flight patterns (e.g., respective control commands received by the first and the second client device having different trajectory types and speeds). In some embodiments, respective control commands sent to and received by the first and the second client devices are selected such that image capture by the first and second client devices is synchronized (e.g., images are captured and obtained at aligned locations so they can be stitched).

In some embodiments, the one or more control commands are based on an identified characteristic of the one or more first and/or second time-stamped images, or of the first and/or second environmental regions. Characteristics may correspond to features of interest observable in the images or environmental regions (e.g., specific portions of an image, objects observed in an image/environmental regions, such as animals, insects, sections of crops, etc.). Additionally and/or alternatively, characteristics correspond to, relate to, or indicate technical aspects or a status of image data or respective meta data, such as a quality (e.g., clarity, sharpness, focus, color accuracy, etc.), completeness (e.g., missing, incomplete, or deficient image data/meta data of an environmental region, feature of interest, etc.), or resolution (e.g., resolution below a predefined threshold) of the image data or respective meta data. Characteristics may be identified manually (e.g., portions of images selected by a user upon reviewing the captured images) or through image processing (e.g., performed by the remote processing device). In some embodiments, characteristics are identified (and thus control commands are generated) in real-time (i.e., based on real-time image processing performed during image capture) or alternatively, after the first and/or second time-stamped images and respective sets of meta data have been received and processed by a remote processing device (e.g., performed by processing device 108, the identified characteristics being sent to the client/drone devices thereafter).

In some embodiments, the one or more control commands are commands for remedying (e.g., adjusting, correcting, compensating) an identified characteristic (e.g., incomplete image data) of the captured images or environmental regions. The commands instruct the client devices and/or drone devices to obtain, for example, more image data (e.g., commands for capturing additional time-stamped images at specific coordinates), image data at higher resolutions, and/or image data at closer/farther distances. The control commands may include modified parameters of a flight pattern (e.g., instructing a drone device to fly closer to a region of interest) and/or image capture settings (e.g., increasing an image capture resolution) for remedying the identified characteristics. In some embodiments, an identified characteristic corresponds to a feature of interest observable in the images or environmental regions that is mobile (i.e., location information changes over time) (e.g., bird, animal, insect, etc.), and the one or more control commands include modified parameters of a flight pattern (e.g., instructing a drone device to track and fly closer to the feature of interest) and/or image capture settings (e.g., increasing an image capture resolution, capturing additional images, etc.) for tracking, and capturing images and/or respective meta data, for the feature of interest.

In some embodiments, the one or more control commands are sent to one or more client devices of the plurality of client devices (or alternatively, one or more drone devices of the plurality of drone devices) based on a respective ability to remedy the identified characteristic, wherein the respective ability to remedy is based on technical capabilities of the client/drone devices (e.g., client device with most available storage, highest resolution image sensor, etc.) or meta data (e.g., commands sent to client devices in closest proximity to region of interest that has insufficient image data).

In some embodiments, the second client device receives, from the first client device (and/or the first drone device), one or more control commands for manipulating a flight pattern of the second airborne drone device. In some embodiments, the first client device receives control commands (e.g., from a remote control device) and re-broadcasts the control commands to the second client device, for execution by the second drone device. In some embodiments, the first client device identifies one or more characteristics of the one or more first time-stamped images or of the first environmental region (e.g., identifying in real-time portions of the captured images having insufficient image data) and, based on the one or more identified characteristics, generates and sends to the second client device (and/or second drone device) one or more control commands for remedying the one or more identified characteristics (e.g., commands modifying a flight pattern to navigate to a region of interest for which there is insufficient image data, and commands including image capture settings for obtaining high-resolution images of the region of interest).

In some embodiments, the second client device sends (562), to the remote processing device, the one or more second time-stamped images and the respective sets of meta data for the one or more second time-stamped images. In some embodiments, the one or more first time-stamped images and the one or more second time-stamped images are formatted (564) to be stitched together using the respective sets of meta data, wherein stitching together the one or more first time-stamped images and the one or more second time-stamped images thereby forms a composite image (e.g., using location information obtained by the first and second client devices to align the first and second time-stamped images for stitching).

Any operations performed by the second client device (e.g., steps of the method 550, FIG. 5D) may be performed in accordance with any of the embodiments described with respect to the first client device (e.g., the method 500, FIGS. 5A-5C). Furthermore, any respective operations performed by the first and/or second client device may be performed additionally, alternatively, and/or concurrently with one another (e.g., concurrent obtaining of time-stamped images). Moreover, any operations described with respect to the first and/or second client device may be analogously performed by one or more additional client devices of the device environment 100 (or other devices/systems described herein, such as an additional drone device), additionally, alternatively, and/or concurrently with the operations of the first and/or second client device. As described above, additional time-stamped images and respective sets of meta data may, for example, be stitched together to form an enhanced and more comprehensive composite image. An example in which multiple client devices (e.g., client devices 104-1 through 104-n) are used for concurrent and varied data capture is illustrated in FIG. 4B.

For situations in which the systems discussed above collect information about users, the users may be provided with an opportunity to opt in/out of programs or features that may collect personal information (e.g., information about a user's preferences or a user's contributions to social content providers). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A method of remote sensing using a plurality of drone devices, comprising:
at a first self-contained battery operated device fixedly mounted to a first drone device in the plurality of drone devices, the first self-contained battery operated device including, connected by a common bus, one or more first processors, a first accelerometer, a first gyroscope, a first location detection device, a first two-dimensional pixilated detector, and memory for storing one or more programs for execution by the one or more first processors:
capturing one or more first time-stamped images of a first environmental region using the first two-dimensional pixilated detector at a time when the first drone device is airborne;
for each respective first time-stamped image of the captured one or more first time-stamped images, obtaining a respective set of meta data, the respective set including:
rotational values obtained using the first gyroscope, the rotational values indicating a relative orientation of the first self-contained battery operated device with respect to a respective reference orientation at a time when the respective first time-stamped image is captured; and
location information obtained using the first location detection device at a time when the respective first time-stamped image is captured; and
sending, to a remote processing device, the one or more first time-stamped images and the respective sets of meta data for the one or more first time-stamped images.

2. The method of claim 1, wherein capturing the one or more first time-stamped images includes storing the one or more first time-stamped images in a first memory location of the memory of the first self-contained battery operated device.

3. The method of claim 1, wherein the rotational values include roll, pitch, yaw axis values and wherein the meta data further comprises movement data from the first accelerometer.

4. The method of claim 1, wherein a respective set of meta data for a respective first time-stamped image further includes altitude information, indicating a respective altitude of the first self-contained battery operated device when the respective time-stamped image was captured.

5. The method of claim 1, wherein the one or more first time-stamped images are formatted to be stitched together using the respective sets of meta data, wherein stitching together the one or more first time-stamped images thereby forms a composite image.

6. The method of claim 1, further comprising:
receiving, from a remote control device over a wireless communications channel, and providing, to the first airborne drone device, one or more control commands for manipulating a flight pattern of the first airborne drone device.

7. The method of claim 6, wherein the one or more control commands correspond to commands for executing a flight pattern having an orbital trajectory.

8. The method of claim 6, wherein the one or more control commands correspond to commands for executing a flight pattern having a linear trajectory.

9. The method of claim 6, wherein sending the one or more first time-stamped images and the respective sets of meta data to the remote processing device includes transmitting the one or more first time-stamped images and the respective sets of meta data over the wireless communications channel.

10. The method of claim 6, wherein:
the first self-contained battery operated device is a first smart phone and the remote control device is a second smart phone, and
the control commands received from the second smart phone are based on user inputs detected within an instance of a drone control application executing on the second smart phone.

11. The method of claim 1, wherein the sending includes transferring the one or more first time-stamped images and the respective sets of meta data to the remote processing device via a wired interface.

12. The method of claim 1, wherein the sending includes transmitting the one or more first time-stamped images and the respective sets of meta data to the remote processing device via a wireless communications interface.

13. The method of claim 1, wherein:
the first self-contained battery operated device further comprises a communications device configured for communication using a cellular communication protocol, and
the sending includes transmitting to the remote processing device, with the cellular communication protocol, the one or more first time-stamped images and the respective sets of meta data.

14. The method of claim 13, wherein transmitting to the remote processing device is performed concurrently with capturing the one or more first time-stamped images.

15. The method of claim 1, wherein the one or more first time-stamped images comprise a video stream.

16. The method of claim 1, further comprising:
at a second self-contained battery operated device fixedly mounted to a second drone device, the second self-contained battery operated device including, connected by a common bus, one or more second processors, a second accelerometer, a second gyroscope, a second location detection device, a second two-dimensional pixilated detector, and memory for storing one or more programs for execution by the one or more second processors:
capturing one or more second time-stamped images of a second environmental region using the second two-dimensional pixilated detector at a time when the second drone device is airborne;
for each of the captured one or more second time-stamped images, obtaining a respective set of meta data, the respective set including:
rotational values obtained using the second gyroscope, the rotational values indicating a relative orientation of the second self-contained battery operated device with respect to a respective reference orientation at a time when the respective first time-stamped image is captured; and
location information obtained using the second location detection device at a time when the respective first time-stamped image is captured;
sending, to the remote processing device, the one or more second time-stamped images and the respective sets of meta data for the one or more second time-stamped images.

17. The method of claim 16, further comprising, at the second self-contained battery operated device:
receiving, from a remote control device over a wireless communications channel, and providing, to the first airborne drone device and the second airborne drone device, one or more control commands for manipulating respective flight patterns of the first airborne drone device and the second airborne drone device.

18. The method of claim 16, further comprising:
at the first self-contained battery operated device:
receiving, from a remote control device over a wireless communications channel, and providing, to the first airborne drone device, one or more control commands; and
at the second self-contained battery operated device:
receiving, from the remote control device over the wireless communications channel, and providing, to the second airborne drone device, the one or more control commands,
wherein the one or more control commands are based on an identified characteristic of the one or more first time-stamped images, the one or more second time-stamped images, the first environmental region, and/or the second environmental region, and
wherein the one or more control commands include one or more commands for remedying the identified characteristic.

19. The method of claim 17, wherein the identified characteristic corresponds to a portion of the one or more first and/or second time-stamped images for which insufficient image data and/or meta data was captured by the first self-contained battery operated device and/or the second self-contained battery operated device, and wherein the one or more control commands include instructions for capturing additional time-stamped images of the portion of the one or more first and/or second time-stamped images.

20. The method of claim 17, wherein the identified characteristic corresponds to a portion of the one or more first and/or second time-stamped images having a resolution that is below a resolution threshold, and wherein the one or more control commands include instructions for capturing additional time-stamped images, at a resolution higher than the resolution threshold, of the portion of the one or more first and/or second time-stamped images.

21.-27. (canceled)
